(19) United States
(12) Patent Application Publication
(10) Pub. No.: US 2007/0023047 A1
(43) Pub. Date: Feb. 1, 2007

(54) Face mask particularly useful as medical face mask

(76) Inventor: Moshe Zalsman, Ramot-HaShavim (IL)

Correspondence Address: Martin Moynihan;c/o Anthony Castorina, Suite 207, 2001 Jefferson Davis Highway, Arlington, VA, 22202, US

(21) Appl. No.: 11/188,907

(22) Filed: Jul. 26, 2005

(51) Int. Cl. A62B 23/02; A62B 18/02

(52) U.S. Cl. 128/206.19

(57) ABSTRACT

A face mask particularly for dentists includes a masking band sized and configured to cover at least the mouth and nasal regions of the wearer; and a separate strip attached at its opposite ends to the opposite ends of the masking band. The intermediate portion of the separate strip carries an illustration of a smiling mouth in the mouth region, and is unattached to the masking band such that deformations of the masking band to accommodate itself to the face of the wearer is permitted by, and does not affect, the separate strip carrying the illustration of the smiling mouth.

### FIELD AND BACKGROUND OF THE PRESENT INVENTION

The present invention relates to face masks. The invention is particularly useful as a medical face mask, such as a face mask to be worn by a dentist or doctor, and is therefore described below with respect to such a mask.

Medical face masks are commonly used by dentists, doctors, and other health attendants, when rendering medical treatment in order to protect the health attendant from receiving bacteria or other germs from the patient, and vice versa. The conventional medical face mask includes a masking band sized and configured to cover at least the mouth and nasal regions of the wearer, and a pair of elastic loops enabling the mask to be worn by releasably engaging the loops with the ears of the wearer. The mask thus presents a physical barrier between the patient and the health attendant rendering the medical treatment.

Where the patient is receiving the medical treatment, particularly dental treatment from a dentist, the patient is frequently in a tensed condition. Such a tensed condition is helpful neither to the patient receiving the treatment, nor to the dentist rendering the treatment.

### OBJECTS AND BRIEF SUMMARY OF THE PRESENT INVENTION

An object of the present invention is to provide a face mask particularly useful by a health attendant, e.g., a dentist, in order to help relieve the tension in the patient at the time the health attendant is rendering a medical treatment, e.g., a dental treatment to the patient.

According to one aspect of the present invention, there is provided a face mask including a masking band sized and configured to cover only the mouth and nasal regions of a wearer; characterized in that the masking band includes an illustration of a smiling mouth in the mouth region.

Thus, when the mask is used by a dentist rendering a dental treatment to a patient, the viewing of the smiling mouth by the patient has been found to help relieve tension in the patient at the time of the dental treatment, and to create a more friendly atmosphere during the dental treatment. Such relief in tension is to the benefit of the patient, as well as to the dentist rendering the dental treatment.

According to another aspect of the present invention, there is provided a medical face mask, comprising: a masking band sized and configured to cover at least the mouth and nasal regions of a wearer; and a separate strip attached at its opposite ends to the opposite ends of the masking band; the intermediate portion of the separate strip carrying an illustration of a mouth in the mouth region, and is unattached to the masking band, such that deformations of the masking band to accommodate itself to the face of the wearer is permitted by, and does not affect, the separate strip carrying the illustration of the mouth.

According to further features in the described preferred embodiment, the separate strip is transparent except for the illustration of a smiling mouth such that the strip is not visually noticeable by an observer except for the illustration of the smiling mouth. The separate strip is of stiffer sheet material than the masking band. The masking band includes a pair of elastic loops enabling the mask to be worn by releasably engaging the loops with the ears of the wearer.

In the described preferred embodiment, the intermediate portion of the masking band between its opposite longitudinal edges is formed with pleats to permit the masking band to deform and conform to the face of the wearer. The opposite longitudinal edges, and the opposite transverse edges, of the masking band include plastic strips for strength, and the intermediate portion of the masking band formed with the pleats is of a porous sheet material.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a front view of a medical face mask constructed in accordance with the present invention;

FIG. 2 is a rear view of the medical face mask of FIG. 1;

FIG. 3 is a transverse sectional view along line III - - - III of FIG. 1; and

FIG. 4 is a transverse sectional view along IV - - - IV of FIG. 1.

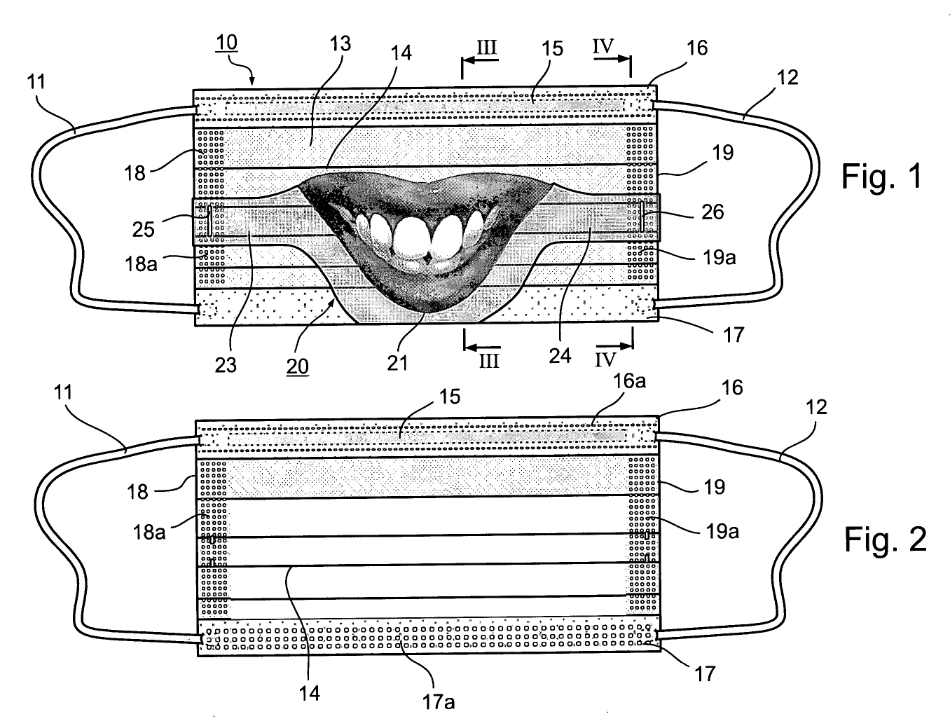

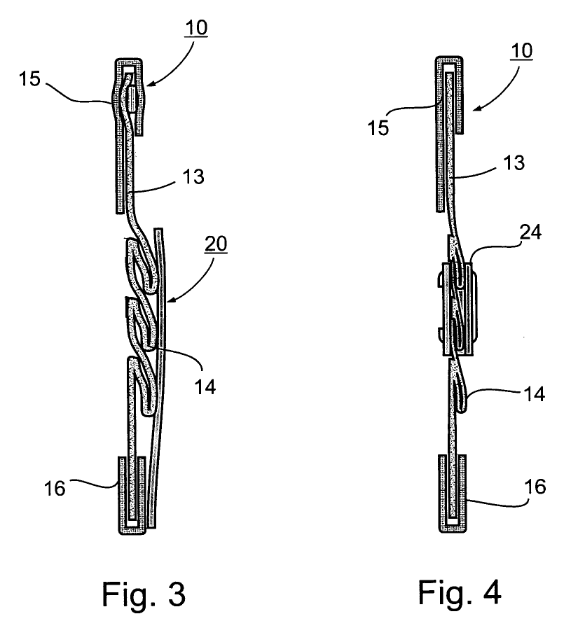

It is to be understood that the foregoing drawings and the description below are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiment described is for purposes of example only, and that the invention is capable of being embodied in other forms and applications than described herein.

### DESCRIPTION OF A PREFERRED EMBODIMENT

The face mask illustrated in the drawings is a medical face mask particularly for dentists. As indicated above, its object to help relieve the tension usually existing in a patient at the time of receiving medical, e.g., dental treatment, by confronting the patient with somewhat of a comical view at the time of the treatment. This is done by confronting the patient, when viewing the face mask worn by the dentist during the dental treatment, with an illustration of a smiling mouth in the mouth region of the face mask.

The face mask illustrated in the drawings includes two basic components: a masking band, generally designated 10, sized and configured to cover at least the mouth and nasal regions of the dentist or other wearer of the mask; and a separate strip, generally designated 20, carrying an illustration of a smiling mouth in the mouth region. The effect is that the patient, during the time of the dental treatment, sees the dentist's face but not the dentist's mouth covered by the masking band: rather, the patient sees in the region of the dentist's mouth a smiling mouth which never changes its smiling expression. The purpose of the mask is to help cause the normally tense feeling of the patient to give way to a more relaxed feeling when viewing the comically-looking, smiling, mouth of the mask.

The masking band 10 of the face mask illustrated in the drawings may be of any conventional construction. In the illustrated mask, it includes a pair of elastic loops, 11, 12, at its opposite ends enabling the mask to be worn by applying the loops over the ears of the dentist or other wearer. The masking band 10 is of rectangular configuration. Its central portion 13 for covering the mouth and nasal regions of the wearer is preferably made of a porous sheet material, e.g., paper, to permit breathing. It is formed with pleats, as shown at 14, to permit the central portion to conform to the contour of the wearer's face. A stiffening strip is preferably embedded within the central portion 13 to extend longitudinally parallel to its upper edge, in order to enable the band to be easily bent to conform to the contour of the wearer's face.

The central region 13 of the masking band 10 is bordered on its opposite longitudinal edges by plastic strips 16, 17, and on its opposite transverse edges by similar plastic strips 18, 19, to provide the necessary physical strength to the mask. Strips 16-19 are preferably formed with venting apertures, as shown at 16a-19a, respectively, to prevent the accumulation of perspiration under the plastic strips.

Preferably, the front face of the central portion 13 of the masking band is skin-colored, so as to somewhat blend with the color of the skin of the dentist or other wearer of the mask.

The separate strip 20 carrying the illustration of a smiling mouth, as shown at 21, is preferably of a transparent plastic material somewhat stiffer than the sheet material of the masking band 10. As shown in the drawings, the separate strip 20 is relatively wide in the central mouth region to accommodate the illustration of the smiling mouth 21. The opposite ends of the separate strip 20 are of reduced width, as shown at 23 and 24, and are secured at their opposite ends to the masking band 10, as shown at 25 and 26, respectively. Any suitable means may be used for fixing the opposite ends 23, 24 to the opposite ends of the masking band 10, e.g. staples, stitching, glue, etc. Only the opposite ends 23, 24 of strip 20 are secured to the band. That is, the intermediate portion of plastic strip 20 is not secured to the underlying masking band, such that deformation of the central portion 13 of the masking band, (e.g. as accommodated by the pleats 14) in order to conform the mask to the face of the dentist or other wearer, is permitted by the plastic strip 20 and does not change the appearance of the smiling mouth 21 illustrated on the plastic strip.

Except for the illustration 21 of the smiling mouth, plastic strip 20 is otherwise transparent. Thus, the portions of the masking band 10 underlying the end portions 23, 24 of the separate plastic strip are viewable through the transparent end portions. Since the so-viewed portion of the masking band 10 is skin-colored, the illustration 21 of the smiling mouth appears to be the actual mouth of the dentist or other wearer of the mask, thereby creating the above-described comical situation which helps to relieve the tension during the dental treatment.

While the invention has been described with respect to one preferred embodiment, it will be appreciated that this is set forth merely for purposes of example, and that many other variations may be made. For example, the smiling mouth, or other comical illustration of a mouth, could be applied to other face mask constructions. Also, while the illustrated face mask is particularly useful for dentists in order to relieve tension during a dental treatment, it will be appreciated that the invention could be implemented in other face masks to present various comical appearances.

Many other variations, modifications and applications of the invention will be apparent.

What is claimed is:

1. A face mask including a masking band sized and configured to cover only the mouth and nasal regions of a wearer; characterized in that the masking band includes an illustration of a smiling mouth in the mouth region.

2. The mask according to claim 1, wherein the illustration of a mouth is carried by a separate strip attached at its opposite ends to the opposite ends of the masking band, with the intermediate portion of the strip unattached to the masking band, such that deformations of the masking band to accommodate it to the face of the wearer are permitted by, and do not affect, the separate strip carrying the illustration of a mouth.

3. The mask according to claim 2, wherein the separate strip is transparent except for the illustration of said mouth such that the strip is not visually noticeable by an observer except for the illustration of the mouth.

4. The mask according to claim 2, wherein the separate strip is of stiffer sheet material than said masking band.

5. The mask according to claim 1, wherein the masking band includes a pair of elastic loops enabling the mask to be worn by releasably engaging the elastic loops with the ears of the wearer.

6. The mask according to claim 1, wherein the intermediate portion of the masking band between its opposite longitudinal edges is formed with pleats to permit the masking band to deform and conform to the face of the wearer.

7. The masking band according to claim 6, wherein the upper portion of the masking band includes a stiffening strip extending longitudinally thereof.

8. The mask according to claim 6, wherein the opposite longitudinal edges, and the opposite transverse edges, of the masking band include plastic strips for strength, and the intermediate portion of the masking band formed with the pleats is of a porous sheet material.

9. A medical face mask comprising: a masking band sized and configured to cover at least the mouth and nasal regions of a wearer;
and a separate strip attached at its opposite ends to the opposite ends of the masking band;
the intermediate portion of the separate strip carrying an illustration of a mouth in the mouth region, and is unattached to the masking band, such that deformations of the masking band to accommodate itself to the face of the wearer is permitted by, and does not affect, the separate strip carrying the illustration of the mouth.

10. The mask according to claim 9, wherein the illustration is of a smiling mouth.

11. The mask according to claim 9, wherein the separate strip is transparent except for the illustration of said mouth such that the strip is not visually noticeable by an observer except for the illustration of the mouth.

12. The mask according to claim 10, wherein the separate strip is of stiffer sheet material than said masking band.

13. The mask according to claim 9, wherein the masking band includes a pair of elastic loops enabling the mask to be worn by releasably engaging the elastic loops with the ears of the wearer.

14. The mask according to claim 9, wherein the intermediate portion of the masking band between its opposite longitudinal edges is formed with pleats to permit the masking band to deform and conform to the face of the wearer.

15. The masking band according to claim 14, wherein the upper portion of the masking band includes a stiffening strip extending longitudinally thereof.

16. The mask according to claim 14, wherein the opposite longitudinal edges, and the opposite transverse edges, of the masking band include plastic strips for strength, and the intermediate portion of the masking band formed with the pleats is of a porous sheet material.
